(19) United States
(12) Patent Application Publication
(10) Pub. No.: US 2003/0042302 A1
(43) Pub. Date: Mar. 6, 2003

(54) Apparatus and method to display a logo

(75) Inventor: Cheon-seong Lee, Gyeinggi-do (KR)

Correspondence Address: STAAS & HALSEY LLP, 700 11TH STREET, NW, SUITE 500, WASHINGTON, DC, 20001, US

(73) Assignee: Samsung Electronics Co., Ltd.

(21) Appl. No.: 10/226,250

(22) Filed: Aug. 23, 2002

(30) Foreign Application Priority Data
Aug. 25, 2001 (KR) 2001-51587

(51) Int. Cl. G06F 7/08

(52) U.S. Cl. 235/381

(57) ABSTRACT

An apparatus and method thereof to display a logo on a screen of an optical disc playback apparatus includes a storage unit storing logo data, wherein the storage unit is removable from the optical disc playback apparatus. A controller checks whether the storage unit is installed in the optical disc playback apparatus when the optical disc playback apparatus is turned on, and outputs the logo data stored in the storage unit when the storage unit is installed. An image processor performs image processing on the logo data stored in the storage unit controlled by the controller.

### CROSS-REFERENCE TO RELATED APPLICATIONS

This application claims the benefit of Korean Application No. 2001-51587, filed Aug. 25, 2001, in the Korean Patent Office, the disclosure of which is incorporated herein by reference.

### BACKGROUND OF THE INVENTION

1. Field of the Invention

The present invention relates to an apparatus and method to play back an optical disc, and more particularly, to an apparatus and method to display a logo on a screen selected by a user, using a smart media when an optical disc playback apparatus is turned on.

2. Description of the Related Art

Advancement in various forms of electronic technology results in an increase in a use of a smart media, which is a type of card that integrates an extensive amount of information. The smart media is convenient to carry and provides ease in processing data where the data is automatically processed through a computerized input/output process. Therefore, the use of the smart media has been rapidly spread, being considered a future device to protect information as well as to store information.

A conventional digital versatile disc (DVD) player displays a logo selected by a user on a screen when turned on. The logo to be displayed on the screen is stored along with a related program in a read-only memory (ROM) in the DVD player. When the DVD player is turned on, the ROM is accessed to display the logo on the screen. However, the conventional DVD player is inconvenient in that the user cannot freely change the logo because the logo is stored in the ROM.

### SUMMARY OF THE INVENTION

Various objects and advantages of the invention will be set forth in part in the description that follows and, in part, will be obvious from the description, or may be learned by practice of the invention.

To accomplish the above and other objects of the present invention, it is a first object of the present invention to provide an apparatus to display a logo on a screen of a DVD player, when the DVD player is turned on, using a smart media that contains information regarding a desired logo.

To accomplish the above and other objects of the present invention, it is a second object of the present invention to provide a method of displaying a desired logo on a screen of a DVD player, when the DVD player is turned on, using a smart media containing logo information.

Accordingly, to accomplish the above and other objects of the present invention, there is provided apparatus to display a logo on a screen of an optical disc playback apparatus, the apparatus including: a storage unit storing logo data, wherein the storage unit is removable from the optical disc playback apparatus; a controller checking whether the storage unit is installed in the optical disc playback apparatus when the optical disc playback apparatus is turned on, and outputting the logo data stored in the storage unit when the storage unit is installed; and an image processor performing image processing on the logo data stored in the storage unit controlled by the controller. Here, the storage unit is a smart media. A memory unit, wherein the controller displays the logo data from the memory unit when the storage unit is not installed in the optical disc playback apparatus.

To accomplish the above and other objects of the present invention, there is provided a method of displaying a logo on a screen of an optical disc playback apparatus, the method including: checking whether a storage unit is installed in the optical disc apparatus containing predetermined logo data when the optical disc playback apparatus is turned on; outputting the logo data stored in the storage unit if the storage unit is present; performing image processing on the logo data from the storage unit and outputting a signal indicative thereof; and displaying the signal on the screen. Furthermore the method stores in a memory unit the logo data, wherein when the storage unit is not installed in the optical disc playback apparatus, the image processing is performed on the logo data from the memory unit and the signal is displayed on the screen.

An apparatus is further provided to display logo data as a video signal on a screen of an optical disc playback apparatus, including: a system controller detecting whether a smart media is installed in the optical disc playback apparatus; a memory unit storing program information to operate the optical disc playback apparatus and the logo data; a smart media storing image data, wherein the image data is read as the logo data when the smart media is installed in the optical disc playback apparatus or the logo data is read from the memory unit when the smart media is not installed in the optical disc playback apparatus; a decoder decoding the logo data output from the smart media or from the memory unit and outputting the decoded logo data as a video signal; and an OSD controller to display the video signal on the screen.

A method is further provided of displaying logo data as a video signal on a screen of an optical disc playback apparatus, including: detecting whether a smart media is installed in the optical disc playback apparatus, wherein the smart media stores image data as the logo data; reading the logo data stored from a particular address in the smart media when the smart media is installed in the optical disc playback apparatus or from a memory unit when the smart media is not installed in the optical disc playback apparatus, wherein program information to operate the optical disc playback apparatus and the logo data are stored in the memory unit; and performing image processing of the logo data and displaying a result indicative thereof on the screen.

These together with other objects and advantages, which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram of an apparatus to display a logo on a screen of an optical disc playback apparatus; and

FIG. 2 is a flow chart illustrating a method of displaying the logo on the screen of the optical disc playback apparatus.

### DETAILED DESCRIPTION OF THE PREFERRED EMBODIMENTS

Hereinafter, embodiments of the present invention will be described in detail with reference to the attached drawings. The present invention may, however, be embodied in many different forms and should not be construed as being limited to the embodiments set forth herein; rather, these embodiments are provided so that the present disclosure will be thorough and complete, and will fully convey the concept of the invention to those skilled in the art.

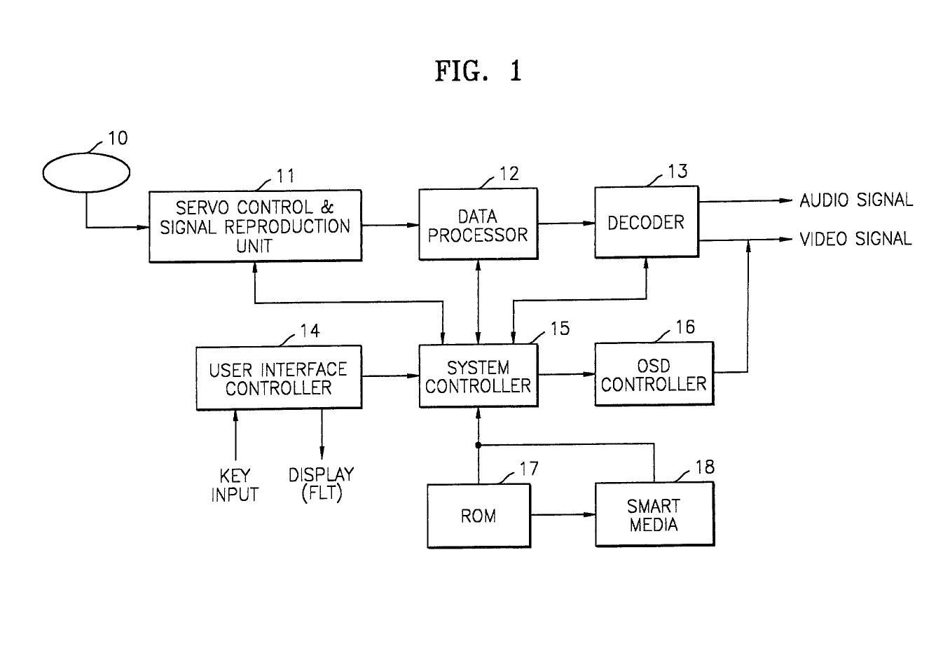

FIG. 1 is a block diagram of an apparatus to display a logo on a screen of an optical disc playback apparatus. This apparatus includes a disc 10, a servo control & signal reproduction unit 11, a data processor 12, a decoder 13, a user interface controller 14, a system controller 15, an OSD controller 16, a ROM or memory unit 17, and a smart media 18. Referring to FIG. 1, the disc 10 may be an optical disc, such as a digital versatile disc (DVD), a compact disc (CD), or a video-CD.

The servo control and signal reproduction unit 11 includes two parts: a servo controller (not shown) and a signal reproducer (not shown). The servo controller controls focus, tracking, and a constant linear velocity (CLV) rotation of the optical disc playback apparatus. The signal reproducer includes a radio-frequency (RF) amplifier, a digital converter, and an equalizer and amplifies an RF signal read by the disc 10 and converts the amplified RF signal into a digital signal, such as an EFM signal (eight-to-fourteen or eight-to-fifteen modulation).

The data processor 12 modulates the EFM signal, corrects an error signal in the modulated EFM signal, stores the corrected signal in a buffer memory (not shown), and transmits the corrected signal to the decoder 13 under the control of the system controller 15. The decoder 13 includes an audio decoder (not shown) and a video decoder (not shown) and decodes input audio and video streams. The decoded audio stream is output via a speaker (not shown), and the decoded video stream is output via a display (not shown). The user interface controller 14 displays reproduction data, such as inputs of a front key indicating an interface between a user and a reproduction period, and a remote controller key, and reproduction time on a fluorescent light tube (FLT). A variety of key signals input to the user interface controller 14 are transmitted to the system controller 15.

The system controller 15 controls the operations of the optical disc playback apparatus, reproduces data contained in the disc 10, and controls other devices for the reproduction of the data. A flag ‘1’ is output to the system controller 15 when the smart media 18 is installed in the optical disc playback apparatus, and a flag ‘0’ is output to the system controller 15 when the smart media 18 is not installed. Accordingly, the system controller 15 is capable of checking for the smart media 18. When the optical disc playback apparatus is first turned on, if the user installs the smart media 18 in the optical disc playback apparatus so as to display the logo on the screen, the system controller 15 checks whether the smart media 18 is installed, and transmits logo data, which is stored in the smart media 18 to the decoder 13. Then, under the control of the system controller 15, the decoder 13 decodes the logo data output from the smart media 18 and outputs the decoded logo data as a video signal. On the contrary, when first turning on the optical disc playback apparatus, if the system controller 15 determines that the smart media 18 is not present in the optical disc playback apparatus, the logo data, which is selected by the user and stored in the ROM 17, is output to the decoder 13. Then, under the control of the system controller 15, the decoder 13 decodes the logo data from the ROM 17 and outputs the decoded logo data as a video signal.

The OSD controller 16 displays the data reproduced by the optical disc playback apparatus on the screen. The ROM 17 stores both a program created by the system controller 15 and the logo data.

The smart media 18 stores image data to be substituted for the logo data. The smart media 18 is advantageous in that it is small in size, making it convenient to carry and is capable of integrating and storing a large quantity of data. For these reasons, the use of the smart media 18 has rapidly increased. In particular, the user can store the image data in the smart media 18 to be displayed.

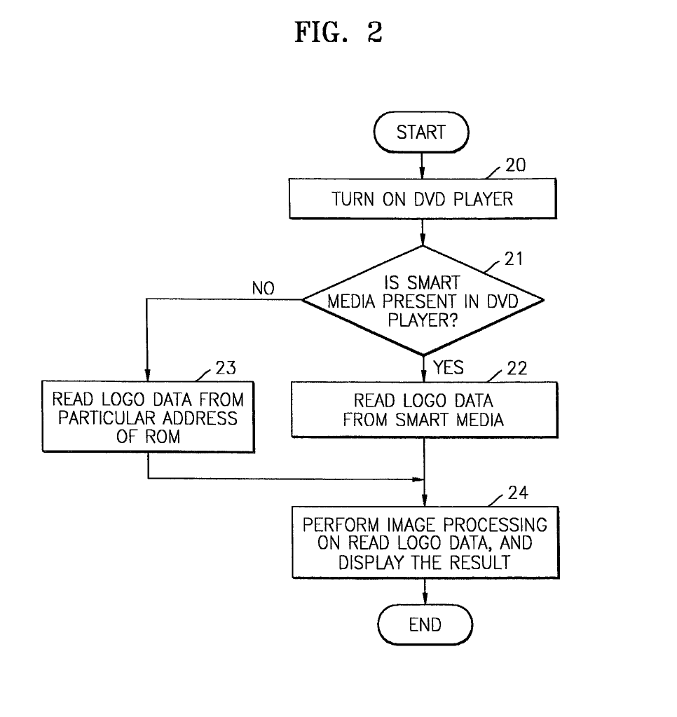

FIG. 2 is a flow chart illustrating a method of displaying the decoded logo data as a video signal on a screen of the optical disc playback apparatus, according to the present invention. At operation 20, the method turns on a DVD player. At operation 21, the method checks whether the smart media 18 is installed in the DVD player. At operation 22, the method reads the logo data stored in a particular address. At operation 23, the method reads the logo data stored in the smart media 18. At operation 24, the method performs image processing of the logo data and displays a result thereof on the screen of the DVD player.

Hereinafter, the method of FIG. 2 will be described in detail with reference to FIGS. 1 and 2. At operation 20, in order to playback the DVD, the user turns on the DVD player by pressing a playback key on the DVD player or a remote control key. In the event that the user wants to display a desired logo data on the screen of the DVD player, the user may store the desired logo data in the smart media 18 and install the smart media 18 in the DVD player before turning on the DVD player.

When the DVD player is turned on, at operation 21, the system controller 15 checks for the smart media 18 in the DVD player. According to the present invention, the flag ‘1’ is output to the system controller 15 when the smart media 18 is present, and the flag ‘0’ is output to the system controller 15 when the smart media 18 is not present. Therefore, the system controller 15 detects the presence of the smart media 18.

At operation 21, if it is determined that the smart media 18 is not present, at operation 22, the logo data is read from a particular address of the ROM 17. Program information to operate the optical disc playback apparatus and the desired logo data are stored in the ROM 17. If the user does not install the smart media 18 in the DVD player, the logo data stored in the ROM 17 is output.

On the contrary, at operation 21, if it is determined that the smart media 18 is present, at operation 23, the desired logo data is read from the smart media 18. In this case, the logo data is the image data that the user wants to display on the screen.

After operation 22 or 23, at operation 24, image processing is performed on the logo data, and the image data is displayed on the screen. More specifically, the system controller 15 reads the logo data from the smart media 18 and outputs the logo data therefrom to the decoder 13. Then, the decoder 13 decodes the logo data and outputs the logo data as a video signal. However, in the event that the smart media 18 is not present, the system controller 15 reads the logo data from the ROM 17, and outputs the stored logo data to the decoder 13. Then, the decoder 13 decodes the logo data and outputs the result as a video signal.

As described above, according to the present invention, a DVD player can access a smart media and display logo data stored in the smart media on a screen, thereby creating ease in changing the logo data when desired.

Although the preferred embodiments of the present invention have been described, it will be understood by those skilled in the art that the present invention should not be limited to the described preferred embodiment, but various changes and modifications can be made within the spirit and the scope of the present invention. Accordingly, the scope of the present invention is not limited within the described range but the following claims.

What is claimed is:

1. An apparatus to display a logo on a screen of an optical disc playback apparatus, the apparatus comprising:
a storage unit storing logo data, wherein the storage unit is removable from the optical disc playback apparatus;
a controller checking whether the storage unit is installed in the optical disc playback apparatus when the optical disc playback apparatus is turned on, and outputting the logo data stored in the storage unit when the storage unit is installed; and
an image processor performing image processing on the logo data stored in the storage unit controlled by the controller.

2. The apparatus as recited in claim 1, wherein the storage unit is a smart media.

3. The apparatus as recited in claim 1, further comprising:
a memory unit, wherein the controller displays the logo data from the memory unit when the storage unit is not installed in the optical disc playback apparatus.

4. A method of displaying a logo on a screen of an optical disc playback apparatus, the method comprising:
checking whether a storage unit is installed in the optical disc apparatus containing predetermined logo data when the optical disc playback apparatus is turned on;
outputting the logo data stored in the storage unit if the storage unit is present;
performing image processing on the logo data in the storage unit and outputting a signal indicative thereof; and
displaying the signal on the screen.

5. The method as recited in claim 4, further comprising:
storing in a memory unit the logo data, wherein when the storage unit is not installed in the optical disc playback apparatus, the image processing is performed on the logo data from the memory unit and the signal is displayed on the screen.

6. An apparatus to display logo data as a video signal on a screen of an optical disc playback apparatus, comprising:
a system controller detecting whether a smart media is installed in the optical disc playback apparatus;
a memory unit storing program information to operate the optical disc playback apparatus and the logo data;
a smart media storing image data, wherein the image data is read as the logo data when the smart media is installed in the optical disc playback apparatus or the logo data is read from the memory unit when the smart media is not installed in the optical disc playback apparatus;
a decoder decoding the logo data output from the smart media or from the memory unit and outputting the decoded logo data as a video signal; and
an OSD controller to display the video signal on the screen.

7. The apparatus as recited in claim 6, further comprising:
a servo control & signal reproduction unit amplifying an RF signal read by a disc and converting the amplified RF signal into a digital signal; and
a data processor modulating and storing the digital signal, wherein the decoder decodes input audio and video streams from the digital signal.

8. The apparatus as recited in claim 7, wherein the servo control & signal reproduction unit controls focus, tracking, and a constant linear velocity (CLV) rotation of the optical disc playback apparatus.

9. The apparatus as recited in claim 7, wherein the data processor corrects an error signal in the modulated digital signal and stores the corrected digital signal.

10. The apparatus as recited in claim 6, further comprising:
a user interface controller displaying reproduction data and reproduction time.

11. The apparatus as recited in claim 6, further comprising:
a system controller controlling operations of the optical disc playback apparatus to reproduce data contained in a disc.

12. A method of displaying logo data as a video signal on a screen of an optical disc playback apparatus, comprising:
detecting whether a smart media is installed in the optical disc playback apparatus, wherein the smart media stores image data as the logo data;
reading the logo data stored from a particular address in the smart media when the smart media is installed in the optical disc playback apparatus or from a memory unit when the smart media is not installed in the optical disc playback apparatus, wherein program information to operate the optical disc playback apparatus and the logo data are stored in the memory unit; and
performing image processing of the logo data and displaying a result indicative thereof on the screen.
